(19) United States
(12) Patent Application Publication
(10) Pub. No.: US 2014/0172306 A1
(43) Pub. Date: Jun. 19, 2014

(54) INTEGRATED OILFIELD DECISION MAKING SYSTEM AND METHOD

(71) Applicant: SCHLUMBERGER TECHNOLOGY CORPORATION, Sugar Land, TX (US)

(72) Inventors: James C. Brannigan, Cypress, TX (US); Lucian Johnston, Sugar Land, TX (US); Ginger Vinyard Hildebrand, Houston, TX (US)

(73) Assignee: SCHLUMBERGER TECHNOLOGY CORPORATION, Sugar Land, TX (US)

(21) Appl. No.: 13/719,039

(22) Filed: Dec. 18, 2012

(51) Int. Cl. G01V 9/00

(52) U.S. Cl. CPC G01V 9/00
USPC 702/13; 702/6; 702/11

(57) ABSTRACT

A method for controlling operations during construction of a subsurface wellbore includes measuring a plurality of wellbore construction parameters. At least one wellbore state parameter is calculated from the wellbore construction parameters in a computer. A plurality of users to communicate with the computer to enable access at least one of the measured wellbore construction parameters and the at least one wellbore state parameter. Depending on a assigned tasks, such user may receive task specific wellbore construction parameters and selected wellbore state parameters for display when a requested is communicated to the computer.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This disclosure relates generally to the field of oilfield data communication and sharing systems. More specifically the disclosure relates to oilfield data communication systems that may facilitate communication between users of data and calculated results therefrom and machines and/or personnel responsible for generating the calculated results.

Oilfield data communication systems known in the art include “two-way” communication of data from, for example, a wellbore in its construction and/or completion phases, and databases located at remote sites such as data analysis centers or data storage facilities. Such systems known in the art may also enable access to data and/or information stored in the databases by selected system users. One example of such as system is described in U.S. Pat. No. 6,751,555 issued to Poedjono.

Other systems for communication of data from a wellsite for access by users include one sold under the service mark MY WELLS, which is a registered service mark of Canrig Drilling Technology, Ltd., Magnolia, Tex.

Measurements made by various instruments and other data obtained at the wellsite may be communicated to a remote database for access by various users, however, a substantial portion of the utility of the measurements and other data results from computations made from the various data. As a non-limiting example, well log data may be processed to provide information concerning fractional volume of pore space (porosity) of various subsurface formations, the fluid content of such pore space, the axial extent of such formations and estimates of fluid productivity of such formations. Having such calculated information available to a user proximate in time to when the measurements are made may be valuable in making decisions concerning further operations to be conducted on a wellbore.

There exists a need for a system to make available to users both unprocessed data as well as calculations and analysis results made therefrom, and to enable users to interact with both the raw data and calculations made therefrom to facilitate decision making concerning a wellbore or wellbores.

### SUMMARY

One aspect of the present disclosure is a method for controlling operations during construction of a subsurface wellbore including measuring a plurality of wellbore construction parameters. At least one wellbore state parameter is calculated from the wellbore construction parameters in a computer. A plurality of users to communicate with the computer to enable access at least one of the measured wellbore construction parameters and the at least one wellbore state parameter. Each of the plurality of users has respective assigned tasks entered into the computer, wherein communication with the computer by at least a first one of the plurality of users results in transmission by the computer of selected ones of the wellbore construction parameters and at least one corresponding wellbore state parameter, the selected wellbore construction parameters and corresponding wellbore state parameter related to the assigned tasks of the at least a first communicating user.

A method for controlling operations during construction of a subsurface wellbore according to another aspect of the present disclosure includes measuring a plurality of wellbore construction parameters. In a first computer, at least a first wellbore state parameter is calculated from at least a first subset of the measured wellbore construction parameters. A plurality of users to communicate with the first computer to enable access to at least one of the plurality of measured wellbore construction parameters and the at least a first calculated wellbore state parameter. In at least a second computer, at least a second wellbore state parameter is computer from at least a second subset of the measured wellbore construction parameters. Each of the plurality of users is enabled access to the at least a first computer or the at least a second computer. The access enables display to an accessing one of the plurality of users of selected ones of the measured wellbore construction parameters and the at least a first and the at least a second wellbore state parameters. The at least a second calculated wellbore state parameter is calculated based on commands communicated to the at least a second computer by an operator thereof

Other aspects and advantages of the invention will be apparent from the description and claims which follow.

### BRIEF DESCRIPTION OF THE DRAWINGS

FIG. 1 shows an example well log data acquisition using a wireline conveyed instrument.

FIG. 2 shows an example of surface data acquisition and well log data acquisition using a logging and measurement while drilling system.

FIG. 3 shows a flow chart of an example process.

FIG. 4 shows an example data communication and processing system.

### DETAILED DESCRIPTION

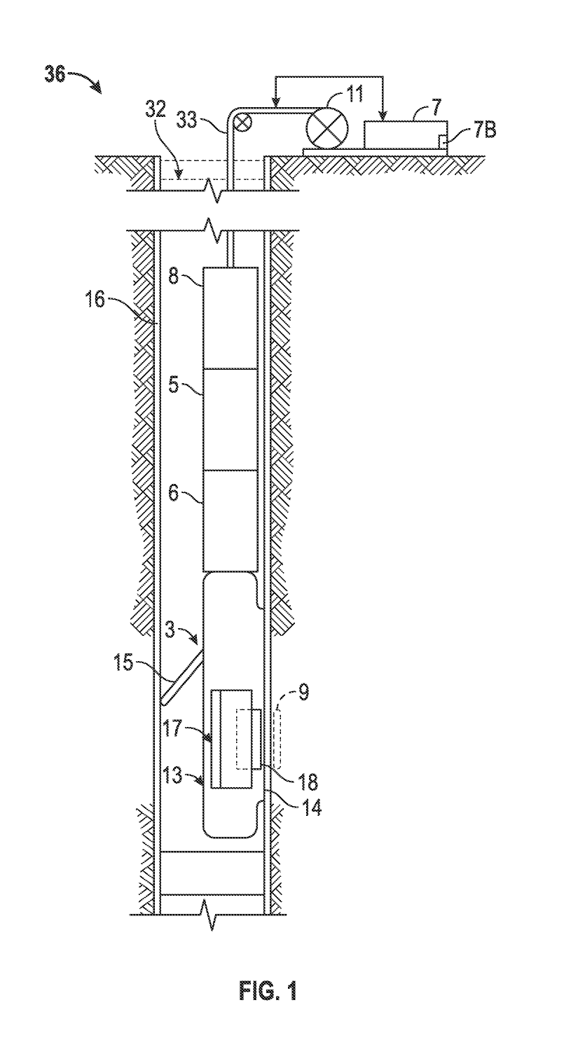

FIG. 1 shows an example manner in which well construction related data, e.g., well log data may be acquired by “wireline”, wherein an assembly or “string” of well logging instruments (including sensors or “sondes” 8, 5, 6 and 3 as will be further explained) is lowered into a wellbore 32 drilled through the subsurface 36 at one end of an armored electrical cable 33. The cable 33 is extended into and withdrawn from the wellbore 32 by means of a winch 11 or similar conveyance known in the art. The cable 33 may transmit electrical power to the instruments 8, 5, 6, 3 in the string, and may communicate signals corresponding to measurements made by the instruments 8, 5, 6, 3 in the string to a recording unit 7 at the earth's surface. The recording unit 7 may include a device (not shown) to measure the extended length of the cable 33. Depth of the instruments 8, 5, 6, 3 within the wellbore 32 is inferred from the extended cable length. The recording unit 7 may include equipment (not shown separately) of types well known in the art for making a record with respect to depth of the instruments (sensors) 8, 5, 6, 3 within the wellbore 32.

The sensors 8, 5, 6 and 3 may be of any type well known in the art for purposes of the defining the scope of the present disclosure. These comprise, without limitation, gamma ray sensors, neutron porosity sensors, electromagnetic induction resistivity sensors, nuclear magnetic resonance sensors, and gamma-gamma (bulk) density sensors. Some sensors such as 80, 70, 60 are contained in a sonde “mandrel” (axially extended cylinder) which may operate effectively near the center of the wellbore 32 or displaced toward the side of the wellbore 32. Others sensors, such as a density sensor 3, include a sensor pad 17 disposed to one side of the sensor housing 13 and have one or more detecting devices 14 therein. In some cases the sensor 3 includes a radiation source 18 to activate the formations 36 proximate the wellbore 32. Such sensors are typically responsive to a selected zone 9 to one side of the wellbore 32. The sensor 30 may also include a caliper arm 15 which serves both to displace the sensor 30 laterally to the side of the wellbore 32 and to measure an apparent internal diameter of the wellbore 32.

The instrument configuration shown in FIG. 1 is only meant to illustrate in general terms acquiring “well log” data by “wireline” and is not intended to limit the scope of the present disclosure as to the manner in which data are acquired at a wellsite or the type of data applicable to a system and method as will be further explained herein.

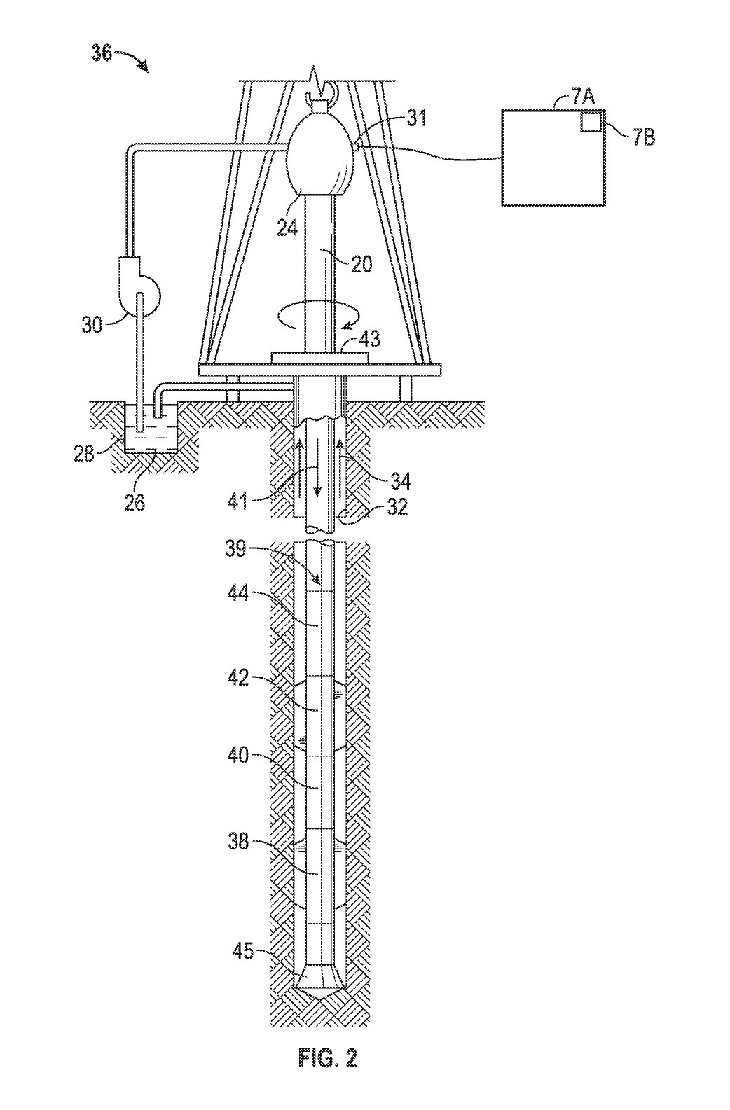

FIG. 2 shows an example configuration for acquiring well log data using a logging while drilling (LWD) system 39. The LWD system 39 may include one or more collar sections 44, 42, 40, 38 coupled to the lower end of a drill pipe 20. The system 39 includes a drill bit 45 at the bottom end to drill the wellbore 32 through the earth 36. Drilling is performed by rotating the drill pipe 20 by means of a rotary table 43. During rotation, the pipe 20 is suspended by equipment on a drill rig 10 including a swivel 24 which enables the pipe 20 to rotate while maintaining a fluid tight seal between the interior and exterior of the pipe 20. Mud pumps 30 draw drilling fluid (“mud”) 26 from a tank or pit 28 and pump the mud 26 through the interior of the pipe 20, down through the LWD system 39, as indicated by arrow 41. The mud 26 passes through orifices (not shown) in the bit 45 to lubricate and cool the bit 45, and to lift drill cuttings in through an annulus 34 between the pipe 20, LWD system 39 and the wellbore 32.

The collar sections 44, 42, 40, 38 include sensors (not shown) therein which make measurements of various properties of the earth formations 36 through which the wellbore 32 is drilled. These measurements are typically recorded in a recording device (not shown) disposed in one or more of the collar sections 44, 42, 40, 38. LWD systems known in the art typically include one or more “measurement while drilling” (MWD) sensors (not shown separately) which measure selected drilling parameters, such as inclination and azimuthal trajectory of the wellbore 32. Other drilling sensors known in the art may include axial force (weight) applied to the system 39, and shock and vibration sensors.

The LWD system 39 typically includes a mud pressure modulator (not shown separately) in one of the collar sections 44. The modulator (not shown) applies a telemetry signal to the flow of mud 26 inside the system 39 and pipe 20 where it is detected by a pressure sensor 31 disposed in the mud flow system. The pressure sensor 31 is coupled to detection equipment (not shown) in the surface recording system 7A which enables recovery and recording of information transmitted in the telemetry scheme sent by the LWD system 39. As explained in the Background section herein, the telemetry scheme includes a subset of measurements made by the various sensors (not shown separately) in the LWD system 39. The remainder of the measurements made by the sensors (not shown) in the system may be transferred to the surface recording system 7A when the LWD system 39 is withdrawn from the wellbore 32.

Just as explained with reference to the wireline acquisition method and system shown in FIG. 1, the LWD acquisition system and method shown in FIG. 1 is only meant to serve as an example of how data are acquired using LWD systems, and is not in any way intended to limit the scope of the disclosure. Other sources of data may include control systems for wellbore pressure control. See, for example, U.S. Pat. No. 6,904,981 issued to van Riet and incorporated herein by reference in its entirety. The system described in the '981 patent can provide automatic control over wellbore fluid pressure, and may also calculate parameters such as expected formation fluid pressure and expected formation fracture pressure. Such data may also be communicated as will be further explained below. Still other sources of data may include, without limitation, so-called “mudlogging” data, wherein drilling fluid returned from the wellbore is analyzed for the presence of materials such as hydrocarbons, and samples of drill cuttings are analyzed for mineral content and grain structure. Still other data may include casing programs (i.e., depth to which casings are set and respective diameters thereof and types of cement to be used) and planned wellbore geodetic trajectory. Any one or more of the foregoing data types, whether measured during drilling of the wellbore, entered into a computer system (explained below) manually or otherwise, may be referred to as a “wellbore construction parameter.”

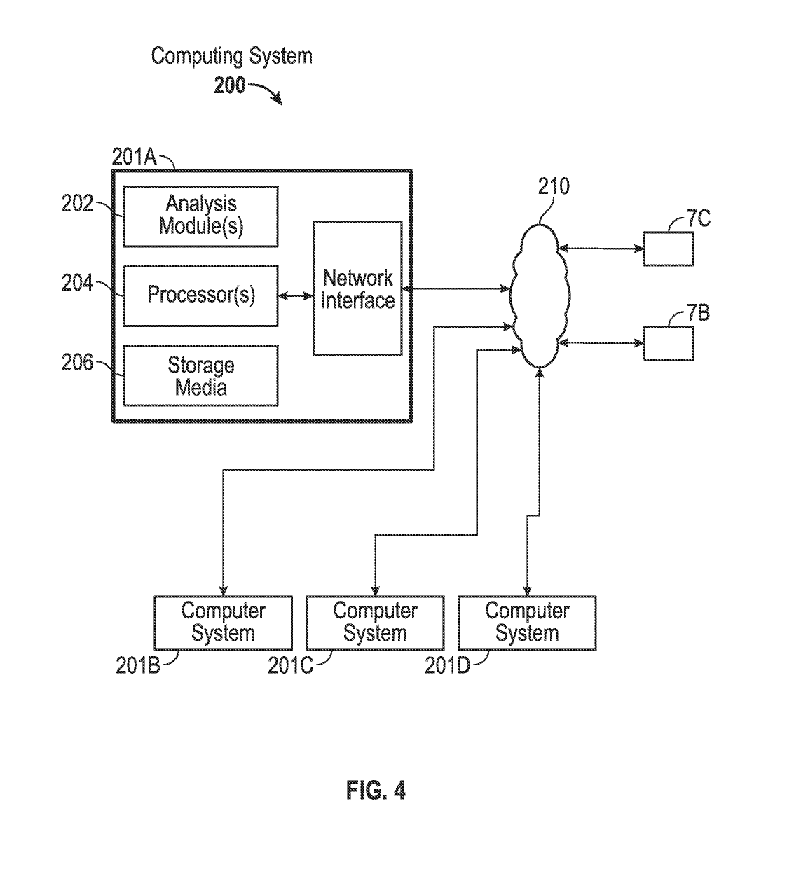

In both FIG. 1 and FIG. 2, the surface recording systems 7, and 7A, respectively, may include a data communication subsystem 7B. Such data communication subsystem may be of any type known in the art suitable for use at the particular location of the welllsite, for example, satellite communication to the Internet, or a dedicated satellite based communication link. Radio communication, wired communication or any other form of data communication is within the scope of the communication subsystem 7B applicable to the present example method and system and the foregoing examples should not be considered limiting. Communication may take place over any form of data network (FIG. 4).

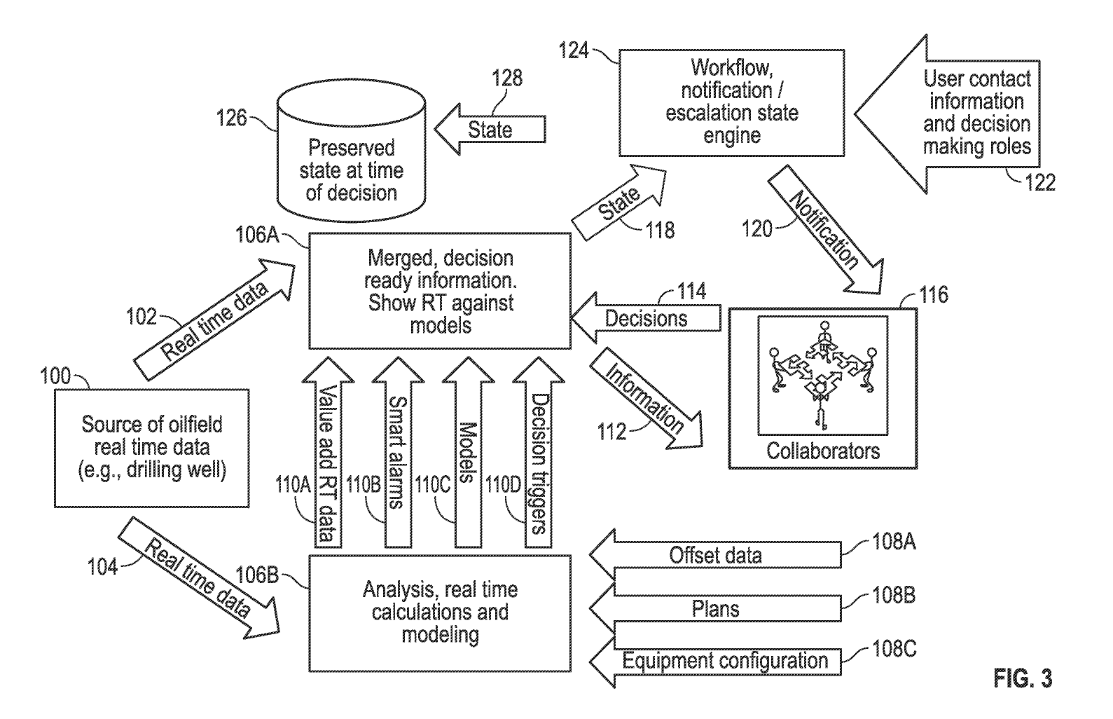

FIG. 3 shows a block diagram of an example implementation of a system and method. Data may be communicated from measurements and data other sources (e.g., computer keyboard entry) at a wellsite at 100. Such data may be communicated using a data communication subsystem such as shown at 7B in FIGS. 1 and 2. Such data may be substantially contemporaneously communicated with its acquisition and/or entry into any data recording or transmission system at the wellsite. Such communication may be referred to as “real time data” and may be communicated to one or more computing systems (e.g., as shown in FIG. 4) as shown at 102 and 104.

Certain functionality may be programmed onto one or more computer systems (FIG. 4). As will be explained with reference to FIG. 4, such computer systems may be singular or plural, and if plural may be collocated or locationally distributed. The functionality which may be programmed onto the one or more computer systems may include, at 106B calculation of selected parameters from the real time data 104. For example, and without limitation, well log data may be used as input to calculate various formation parameters such as porosity, water saturation, net thickness of various formation layers, among others. Drilling parameters calculated may include, for example, and without limitation, rate of axial extension of the wellbore (ROP) and drilling exponent. External inputs may be provided, for example, nearby (offset) wellbore data 108A, well construction plans 108B (e.g., casing programs, planned wellbore trajectory, drilling fluid composition and density plans, among others) and the configuration of the equipment 108C used to obtain the real time data. The external inputs 108A, 108B, 108C may be provided by one or more users, as will be further explained.

At 110A through 110D, calculations made from the real time data at 106B may be associated with certain attributes of the real time data, for example, depths of boundaries of formation layers (formation “tops”), measured pressures in the wellbore compared with those expected, models generated by comparison of the calculations made from the real time data and the external inputs 108A, 108B, 108C, as well as alarms that may be activated when calculated values and/or real time data values result in a deviation from a predetermined range of acceptable values or when the values exceed or fall below predetermined thresholds. Calculated values of any one or more parameters made using any one or more of the wellbore construction parameters may be referred to as a “wellbore state parameter.” The real time data, at 102, may be merged by depth and/or time correlation with the calculated values determined at 106A. The foregoing may be referred to as the “state” of the wellbore at any moment in time, as shown at 118. The state 118 may be communicated to a workflow and/or notification calculator (engine) at 124. The engine 124 may be programmed to notify selected users (to be further explained) when the state 118 is within predetermined ranges or exceeds or falls below selected thresholds (or for example at selected times) for any one or more selected formation and/or wellbore parameters. The notification may be a simple notice, or may be an instruction to one or more selected users that user intervention and/or action is required. When the engine 124 generates a notification or an indication that action is required, the engine 124 may also communicate at 128 and persist the state to a data storage device 126. All of the foregoing functionality may be programmed into one or more computer systems as will be explained with reference to FIG. 4 below.

At 122, various users are defined, and their respective notifications and/or task assignments may be entered into the computer system (FIG. 4). Users may include, for example and without limitation, oil well operator (customer) personnel, such as well log analysts, geologists and drilling engineers. Each such customer user may have predefined notification criteria programmed into the computer system, such that notifications, at 120 are generated and transmitted to the appropriate user when the notification criteria are met. Users may also be service provider representatives, and any of the foregoing may have the same or different functions, e.g., well log analysts, geologists and drilling engineers as the oil company customer users. Notifications 120 may be sent to the service company representative users based upon their self-declared function or tasks within the use of the system and may include simple notifications that an event has occurred or that one or more wellbore or other parameters are within a range or fall outside threshold values for the particular parameter(s).

It will be appreciated that the calculations and merging shown at 106A and 106B may be performed automatically by suitable programming residing on the computer system, and/or may include intervention and operation by one or more service company users or oil company customer users acting on an accessible computer. The latter functionality may be initiated by a notification being sent to one or more of the users who are assigned specific tasks within the wellbore project. For example, a notification 120 may be sent to a service company user well log analyst to review calculations made from well log data (e.g., real time data 102 104) when certain predetermined criteria are met, for example, when calculations indicate that a hydrocarbon bearing formation has been determined to be present. In such examples, the log analyst may change certain calculation input parameters, e.g., offset well data 108A and check the results visually. Correspondingly, a notification 120 may be sent to an oil company user, such as a well log analyst, with the same information. The computer system may be programmed so that both the service company user and the oil company customer user may view the same information 112, and at 116 may jointly or severally make a decision concerning future operations on the wellbore, as shown at 114. As explained above, the state 118 at the time such decision 114 is made may be recorded on a data recording medium 126 for future reference. For purposes of the present disclosure, the term “decision” may mean selection of any one or more wellbore construction or evaluation parameters, i.e., whether to change the selected parameter(s) or to leave them constant.

Another functionality that may be programmed into the computer system is that any of the users may request specific information or explanation from the computer system. For example, a customer geologist may request the depths of formation tops as determined in the calculations 106B, 106A, 114A, 114B. Depending on the specific information requested, the computer system may send a notification 120 to a corresponding user, whether a customer user or a service company user, having assigned tasks that relate to those of the requesting user, so that if the oil company user requires additional information or additional calculations to be performed, such user is put into contact with an appropriate service company user. After such notification 120, the oil company user and the service company user may correspond (collaboration 116) to determine if any changes in the expected operations to take place on the wellbore are required. The correspondence may be, for example, be in the form of chat windows embedded in the display provided by the computer system to the user's access device (FIG. 4), may be by voice, e.g., telephone or video conference, depending on what type of user access device is used be any particular user. Notifications among collaborators are based on the specific roles each individual user of the system has for both the service company users and for the operating company users. For example, the request above would be analyzed for content by the system and as a result then routed to an on duty borehole geologist assigned to the specific project by the service company and/or the oil company user. The person “on duty” for a specific role may be determined, for example, in one of two ways. First, individuals can enter personal data into the system to identify the individuals as having specific roles. Individuals may also remove their personal data as associated with specific roles, or may remove themselves from the system as having any association with a specific wellbore project... Second, the computer system may have a predetermined schedule of the individuals and their duty schedules, wherein such schedule may be entered at the beginning of a project. Personnel who enter personal data concerning roles may do so using any form of access to the system described herein.

Another feature that may be included in some examples is made possible by the recording of the state 118 of the wellbore in the storage medium 126 when a decision 114 is put into effect. If evaluation of one or more wellbore construction or formation evaluation parameters after a decision is made indicates that the decision has had an adverse effect, e.g., ROP is reduced, detected gas in the drilling fluid returns increases, or that torque applied by the drill string indicates that drill cuttings are loading the wellbore, the wellbore trajectory deviates from a predetermined trajectory, among other non-limiting examples, a notification 120 may be sent to selected users depending on the specific parameter that may be adversely affected by the previous decision 114, and on the role (assigned tasks) of the specific individuals stored in the system. The one or more notified users may collaborate at 116 and formulate a new decision 114. The new decision 114 may be entered into the computer system and the monitoring of real time data and calculated results as shown at 106A and 106B may continue. If the adversely affected parameter is determined to be favorably changed, no further notifications therefor may be sent, or a notification of the favorable change in the affected parameter may be sent to the corresponding users. If the adversely affected parameter is determined to be further adversely affected or not favorably changed, then further notifications may be sent to the corresponding users for further collaboration.

The manner in which decisions are entered into the computer system may depend on the initial system configuration. In some examples, the decision procedure may be selected by an appropriate individual representative of the oil company customer. Notifications may be similarly selected at the time the computer system is configured for a particular wellbore.

Offset well data and other data that may be used in analyzing the real time data, e.g., as shown at 108A, 108B, 108C may be accessed through a database which may be located remotely from the wellbore. Using any form of communication system (again described below with reference to FIG. 4), such database or databases may be accessed to obtain any needed additional information. Such database may be under the control of the oil company customer where the additional information includes, for example, offset well data. Instrument configurations and similar information may be disposed on databases operated by the service company.

The manner in which the data are displayed on any remote device, whether computer, tablet, smartphone or other device (FIG. 4) is a matter of discretion for the system designer and is not a limit on the scope of the present disclosure. Communication of data entry into the system and data retrieval and presentation by the system may take place over any known form of electronic communication, including, without limitation, public telephone systems, wireless telephone/data communication systems, dedicated satellite communication systems, and the Internet. Examples of data retrieval and display are shown in U.S. Pat. No. 6,751,555 issued to Poedjono and incorporated herein by reference for all purposes.

FIG. 4 shows an example computing system 200 in accordance with some embodiments. The computing system 200 can be an individual computer system 201A or an arrangement of distributed computer systems. The computer system 201A may include one or more analysis modules 202 that are configured to perform various tasks according to some embodiments, such as the tasks depicted in FIG. 3. To perform these various tasks, the analysis module 202 may execute independently, or in coordination with one or more processors w04, which is (or are) connected to one or more storage media 206. The processor(s) 204 is (or are) also connected to a network interface 208 to allow the computer system 201A to communicate over a data network 210, for example, the Internet, with one or more additional computer systems and/or computing systems, such as 201B, 201C, and/or 201D. Note that computer systems 201B, 201C and/or 201D may or may not share the same architecture as computer system 201A, and may be located in different physical locations, e.g. computer systems 201A and 201B may be in a data processing center on one continent, while in communication with one or more computer systems such as 201C and/or 201D that are located in one or more data centers on shore, aboard ships, at the rig site and/or located in varying countries on different continents.

A processor can include a microprocessor, microcontroller, processor module or subsystem, programmable integrated circuit, programmable gate array, or another control or computing device.

The storage media 206 may be implemented as one or more computer-readable or machine-readable storage media. Note that while in the example shown in FIG. 4 the storage media 206 are depicted as within computer system 201A, in some embodiments, storage media 206 may be distributed within and/or across multiple internal and/or external enclosures of computing system 201A and/or additional computing systems. Storage media 206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 200 is only one example of a computing system, and that computing system 200 may have more or fewer components than shown, may combine additional components not depicted in the exemplary embodiment of FIG. 4, and/or computing system 200 may have a different configuration or arrangement of the components depicted in FIG. 4. The various components shown in FIG. 4 may be implemented in hardware, software, or a combination of hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Access to the computing system 200 may be from the wellsite, e.g., data communication subsystems 7B as explained with reference to FIGS. 1 and 2 wherein data are input to the computing system 200 from the wellsite, or from a plurality of wellsites. Further, access to the computing system 200 may be made through the network interface 210 to remote devices 7C such as smartphones or portable computers having network interface 210 access. Such devices may be used by external system users (e.g., oil producing company personnel), or by internal system users (e.g., service company personnel). The devices may be programmed to receive notification from the system (FIG. 3) when certain criteria are met, as explained above. Such notifications may depend on the type of remote device 7C, and may include, for example and without limitation, SMS text messages, audible alarms, visual alarms or displays. It will be appreciated by those skilled in the art that having multiple computer systems such as shown at 201B, 201C and 201D may enable multiple users to perform individual analyses corresponding to their respective roles in a particular project and communicate the results thereof to the computer system 200 wherein selected users may have access to such analyses.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for controlling operations during construction of a subsurface wellbore, comprising:
measuring a plurality of wellbore construction parameters;
in a computer, calculating at least one wellbore state parameter from the measured wellbore construction parameters;
enabling a plurality of users to communicate with the computer to enable access to at least one of the plurality of measured wellbore construction parameters and the at least one calculated wellbore state parameter;
wherein each of the plurality of users has respective assigned tasks entered into the computer, wherein communication with the computer by at least a first one of the plurality of users results in transmission by the computer of selected ones of the measured wellbore construction parameters and at least one corresponding calculated wellbore state parameter, the selected wellbore construction parameters and corresponding calculated wellbore state parameter related to the assigned tasks of the at least a first communicating user.

2. The method of claim 1 wherein the assigned tasks for the at least a first one of the plurality of users is entered into the computer at a beginning of wellbore construction operations.

3. The method of claim 1 wherein the assigned tasks for the at least a first one of the plurality of users is entered into the computer after a beginning of wellbore construction operations.

4. The method of claim 1 further comprising upon communication with the computer of the at least a first one of the plurality of users, the computer communicates a notification to at least a second one of the plurality of users, the notification comprising at least one of:
indication that the at least a first one of the plurality of users has communicated with the computer; and
the selected ones of the wellbore construction parameters and at least one corresponding wellbore state parameter communicated to the at least a first one of the plurality of users.

5. The method of claim 4 further comprising at least one of the first one of the plurality of users and the second one of the plurality of users communicating to the computer a change in at least one parameter used by the computer to calculate the at least one wellbore state parameter.

6. The method of claim 5 wherein the at least a first user and the at least a second user communicate with each other prior to communicating to the computer the change in the at least one parameter used by the computer.

7. The method of claim 4 wherein the computer sends a notification to at least one of the plurality of users if the wellbore state parameter deviates by a predetermined amount from an expected value as a result of the communicated change in the at least one parameter used by the computer.

8. The method of claim 7 wherein the at least one of the plurality of users comprises at least one of the at least a first user and the at least a second user.

9. The method of claim 7 further comprising at least one of the plurality of users changing the at least one parameter used by the computer.

10. The method of claim 9 wherein the at least one of the plurality of users comprises at least one of the at least a first user and the at least a second user.

11. The method of claim 10 wherein the at least a first user and the at least a second user communicate with each other prior to changing the at least one parameter used by the computer.

12. The method of claim 1 further comprising the computer communicating a notification to at least one selected user when the wellbore state parameter reaches a predetermined value.

13. The method of claim 8 wherein the at least one selected user is determined based on the at least one selected user's tasks entered into the computer and the type of wellbore state parameter.

14. The method of claim 1 wherein the plurality of wellbore construction parameters comprise well log measurements.

15. The method of claim 14 wherein the well log measurements are obtained using at least one of a wireline well logging instrument and a logging while drilling instrument.

16. The method of claim 14 wherein the at least one wellbore state parameter comprises at least one of depths of tops of selected subsurface formations, existence of a hydrocarbon bearing formation and deviation of a wellbore trajectory from a predetermined trajectory.

17. The method of claim 1 wherein communication with the computer by the plurality of users comprises at least one of using public telephone systems, wireless telephone/data communication systems, dedicated satellite communication systems, and the Internet.

18. A method for controlling operations during construction of a subsurface wellbore, comprising:
measuring a plurality of wellbore construction parameters;
in a first computer, calculating at least a first wellbore state parameter from at least a first subset of the measured wellbore construction parameters;
enabling a plurality of users to communicate with the first computer to enable access to at least one of the plurality of measured wellbore construction parameters and the at least a first calculated wellbore state parameter;
in at least a second computer, calculating at least a second wellbore state parameter from at least a second subset of the measured wellbore construction parameters; and
wherein each of the plurality of users is enabled access to the at least a first computer or the at least a second computer, the access enabling display to an accessing one of the plurality of users of selected ones of the measured wellbore construction parameters and the at least a first and the at least a second wellbore state parameters and wherein the at least a second calculated wellbore state parameter is calculated based on commands communicated to the at least a second computer by an operator thereof.

19. The method of claim 18 wherein each of the plurality of users has assigned tasks related to the subsurface wellbore construction entered into at least one of the at least a first computer and the at least a second computer at a beginning of wellbore construction operations.

20. The method of claim 18 wherein each of the plurality of users has assigned tasks related to the subsurface wellbore construction entered into at least one of the at least a first computer and the at least a second computer after a beginning of wellbore construction operations.

21. The method of claim 18 further comprising upon communication with the at least a first computer or the at least a second computer of at least a first one of the plurality of users, the at least a first or at least a second computer communicates a notification to at least a second one of the plurality of users, the notification comprising at least one of:
indication that the at least a first one of the plurality of users has communicated with the computer; and
selected ones of the wellbore construction parameters and at least one corresponding wellbore state parameter requested to be displayed on a device operated by the at least a first one of the plurality of users.

22. The method of claim 18 further comprising at least one of the first one of the plurality of users and the second one of the plurality of users communicating to the at least a first or at least a second computer a change in at least one parameter used by the at least a first or at least a second computer to calculate the at least a first or second wellbore state parameter.

23. The method of claim 22 wherein the at least a first user and the at least a second user communicate with each other prior to communicating to the computer the change in the at least one parameter used by the at least a first or at least a second computer.

24. The method of claim 22 wherein the at least a first or at least a second computer sends a notification to at least one of the plurality of users if the at least a first or at least a second wellbore state parameter deviates by a predetermined amount from an expected value as a result of the communicated change in the at least one parameter used by the at least a first or at least a second computer.

25. The method of claim 24 wherein the at least one of the plurality of users to which the notification is sent comprises at least one of the at least a first user and the at least a second user.

26. The method of claim 18 further comprising the at least a first or at least a second computer communicating a notification to at least one of the plurality of users when the at least a first or second wellbore state parameter reaches a predetermined value.

27. The method of claim 26 wherein the at least one of the plurality of users is determined based on the at least one of the plurality user's tasks entered into the computer and a type of the at least a first or second wellbore state parameter.

28. The method of claim 18 wherein the plurality of wellbore construction parameters comprise well log measurements.

29. The method of claim 28 wherein the well log measurements are obtained using at least one of a wireline well logging instrument and a logging while drilling instrument.

30. The method of claim 18 wherein the at least one of a first and a second wellbore state parameter comprises at least one of depths of tops of selected subsurface formations, existence of a hydrocarbon bearing formation and deviation of a wellbore trajectory from a predetermined trajectory.

31. The method of claim 18 wherein communication with the computer by any one of the plurality of users comprises at least one of using public telephone systems, wireless telephone/data communication systems, dedicated satellite communication systems, and the Internet.

32. The method of claim 18 wherein the at least a first computer and the at least a second computer are embodied in a same physical computer, and wherein the at least a second wellbore state parameter is calculated based on control inputs to the at least a second computer provided by the at least a second user communicated to the at least a second computer using a remote communication device.

33. The method of claim 32 wherein the remote communication device comprises at least one of a terminal connected to at least one of public telephone systems, wireless telephone/data communication systems, dedicated satellite communication systems, and the Internet.

34. The method of claim 18 wherein the at least a first computer and the at least a second computer are embodied in different physical computers, and wherein the at least a second wellbore state parameter is calculated based on control inputs to the at least a second computer provided by the at least a second user.

35. The method of claim 34 wherein the at least a second user provides the control inputs to the at least a second user with control terminal proximate the at least a second computer and the at least a second computer communicates with the at least a first computer using at least one of public telephone systems, wireless telephone/data communication systems, dedicated satellite communication systems, and the Internet.

36. The method of claim 18 further comprising a subset of the plurality of users each communicating control inputs to at least one of the at least a first computer, the at least a second computer and a corresponding computer operated by one or more of the subset of the plurality of users, and further comprising calculating at least one corresponding wellbore state parameter based on the communicated control inputs.

37. The method of claim 36 wherein the communicating by the subset of the plurality of users is performed using at least one of an operating terminal proximate the corresponding computer, and remote communication using at least one of public telephone systems, wireless telephone/data communication systems, dedicated satellite communication systems, and the Internet.
